(19) United States
(12) Patent Application Publication
(10) Pub. No.: US 2026/0171617 A1
(43) Pub. Date: Jun. 18, 2026

(54) Two-Cell Assembly and Battery Pack Including the Same

(71) Applicant: LG Energy Solution, Ltd., Seoul (KR)

(72) Inventors: Jong Pil Jeon, Daejeon (KR); Ju Hwan Shin, Daejeon (KR)

(73) Assignee: LG Energy Solution, Ltd., Seoul (KR)

(21) Appl. No.: 19/312,542

(22) Filed: Aug. 28, 2025

(30) Foreign Application Priority Data
Dec. 18, 2024 (KR) 10-2024-0190415

(51) Int. Cl. H01M 50/507; H01M 10/42; H01M 10/6555; H01M 50/209; H01M 50/249; H01M 50/503; H01M 50/512; H01M 50/519

(52) U.S. Cl. CPC H01M 50/507; H01M 10/4257; H01M 10/6555; H01M 50/209; H01M 50/249; H01M 50/503; H01M 50/512; H01M 50/519; H01M 2220/20

(57) ABSTRACT

In one embodiment according to the present disclosure, a two-cell assembly includes a first battery cell and a second battery cell each having cell leads with opposite polarities on both ends in a length direction, and a pair of busbar blocks, each joined to the same-polarity cell leads of the first battery cell and the second battery cell on opposite sides, and each having a bolt hole extending in a height direction, and the first battery cell and the second battery cell are connected in parallel via the pair of busbar blocks

### CROSS-REFERENCE TO RELATED APPLICATIONS

This application is based on and claims priority from Korean Patent Application No. 10-2024-0190415, filed on Dec. 18, 2024, with the Korean Intellectual Property Office, the disclosure of which is incorporated by reference herein in its entirety.

### TECHNICAL FIELD

The present disclosure relates to a two-cell assembly and a battery pack in which a plurality of battery cells are directly assembled into a pack case in units of the two-cell assembly.

### BACKGROUND

There have been various attempts to increase the space utilization of battery packs, and one approach is a battery pack having a cell-to-pack structure. In the cell-to-pack structure, without a modular structure that accommodates a plurality of batteries in a housing, the plurality of batteries are grouped with a minimum of structure components and are directly assembled into the battery pack. This structure has the advantage of improving the space utilization of the battery pack by reducing the number of structural components.

However, the cell-to-pack structure still has concerns regarding structural issues such as a difficulty in scaling up, which remains important challenges to be addressed. For example, a technique has been disclosed that attempts to efficiently improve the internal structure of battery cells in a battery pack by using electrode tab covers and others. See, for example, Korean Patent Laid-open Publication No. 2023-0058851.

### SUMMARY

The present disclosure provides a two-cell assembly and a battery pack including the same, which may simplify the process of assembling a busbar frame assembly to a conventional battery assembly, eliminate the process of bending leads of battery cells, and enable the simplified battery assembly to be directly mounted into a pack case.

However, the technical issues to be addressed by the present disclosure are not limited to those described above, and other issues not mentioned will be clearly understood by those skilled in the art from the following description of the present disclosure.

A two-cell assembly according to one embodiment of the present disclosure includes a first battery cell and a second battery cell each having cell leads with opposite polarities on both ends in a length direction, and a pair of busbar blocks, each joined to the same-polarity cell leads of the first battery cell and the second battery cell on opposite sides, and each having a bolt hole extending in a height direction, wherein the first battery cell and the second battery cell are connected in parallel via the pair of busbar blocks.

Each cell lead of the first battery cell and the second battery cell may not include a bending structure on a joining structure for the pair of busbar blocks.

The first battery cell and the second battery cell may come into contact with each other on facing sides thereof via a heat dissipation pad and/or a cushioning pad.

Alternatively, the first battery cell and the second battery cell may come into contact with each other on facing sides thereof via a cooling plate.

The cooling plate may include a bottom plate that supports bottom surfaces of the first battery cell and the second battery cell.

Further, the present disclosure provides a battery pack including a plurality of the two-cell assemblies having the above configuration, and a pack case including a busbar frame assembly on which the plurality of two-cell assemblies are mounted with the busbar blocks oriented in a height direction, and on which the busbar blocks are also mounted.

The busbar frame assembly may be installed on a base plate of the pack case.

The busbar frame assembly may be provided with a plurality of busbars, each having a pair of nut holes that communicate with the bolt hole of the busbar block, and each connecting the cell leads of adjacent two-cell assemblies in series.

The plurality of two-cell assemblies may be fixed to the busbar frame assembly and electrically connected to each other by a plurality of bolts that pass through the bolt holes of the busbar blocks and are fastened to the nut holes of the busbars.

The busbar blocks or cell leads of outermost two-cell assemblies, among a plurality of two-cell assemblies arranged in a row, may form a pair of output terminals with opposite polarities for the plurality of two-cell assemblies fixed to the busbar frame assembly.

The plurality of busbars of the busbar frame assembly may be cooled via the base plate.

In one embodiment, the busbar frame assembly may be provided with an integrated circuit assembly including a plurality of sensing plates.

Each of the plurality of sensing plates may be electrically connected to one busbar.

The sensing plate may measure a voltage of the electrically connected busbar.

A pack case according to another embodiment of the present disclosure includes a plurality of two-cell assemblies and a pack case including a busbar frame assembly on which the plurality of two-cell assemblies are mounted with a busbar block oriented in a height direction, and on which the busbar block is also mounted, wherein each of the plurality of two-cell assemblies may include a first battery cell and a second battery cell each having cell leads with opposite polarities on both ends in a length direction, and a pair of the busbar blocks, each joined to the same-polarity cell leads of the first battery cell and the second battery cell on opposite sides, and each having a bolt hole extending in the height direction, and wherein the first battery cell and the second battery cell may be connected in parallel via the pair of busbar blocks.

The busbar frame assembly may be installed on a base plate of the pack case.

The busbar frame assembly may be provided with a plurality of busbars, each having a pair of nut holes that communicate with the bolt hole, and each connecting the cell leads of adjacent two-cell assemblies in series.

The plurality of two-cell assemblies may be fixed to the busbar frame assembly and electrically connected to each other by a plurality of bolts that pass through the bolt hole and are fastened to the nut holes.

The busbar blocks or cell leads of outermost two-cell assemblies, among a plurality of two-cell assemblies arranged in a row, may form a pair of output terminals with opposite polarities for the plurality of two-cell assemblies fixed to the busbar frame assembly.

A vehicle according to one embodiment of the present disclosure may include at least one battery pack.

The two-cell assembly of the present disclosure having the above configuration may be directly mounted into the pack case as a unit of two battery cells. Accordingly, a simplified structure suitable for a cell-to-pack structure may be implemented, which is advantageous for scaling up in size, and even when the battery cells are large, steps such as transport and assembly may be smoothly carried out.

Further, the two-cell assembly of the present disclosure does not include a bending structure of the cell leads for connecting the busbars for every two or three battery cells in the busbar frame assembly. Therefore, the process of assembling the battery cells with the busbar frame assembly is simplified, and defects due to the bending of the battery cell leads may be avoided.

Furthermore, in the battery pack provided by the present disclosure, the plurality of battery cells are directly mounted into the pack case in units of the two-cell assembly. For example, a battery assembly mounted into the pack case does not include the busbar frame assembly, thereby simplifying the process of mounting a plurality of battery cells into the pack case and improving the productivity of the battery pack.

In the battery pack of the present disclosure, the busbar frame assembly is installed directly to the pack case, with the plurality of busbars provided in the busbar frame assembly facing the base plate. In the battery pack, although the busbars form a high-temperature region due to current concentration, the busbars may be effectively cooled through the base plate. Considering this effect, the battery pack of the present disclosure has an advantage from the standpoint of thermal management.

However, the technical effects that may be obtained through the present disclosure are not limited to the above-described effects, and other effects not mentioned will be clearly understood by those skilled in the art from the following description of the present disclosure.

### BRIEF DESCRIPTION OF THE DRAWINGS

The following drawings attached hereto illustrate example embodiments of the present disclosure and, together with the detailed description to be described later, serve to further understand the technical idea of the present disclosure. Therefore, the present disclosure should not be construed as being limited to the matters illustrated in the drawings.

FIG. 1 is a perspective view of a two-cell assembly according to one embodiment of the present disclosure.

FIG. 2 is an exploded perspective view of the two-cell assembly of FIG. 1.

FIG. 3 is a plan view of the two-cell assembly of FIG. 1.

FIG. 4 is a plan view of the two-cell assembly according to another embodiment of the present disclosure.

FIG. 5 is a perspective view of the two-cell assembly according to still another embodiment of the present disclosure.

FIG. 6 is a plan view of a battery pack according to one embodiment of the present disclosure and an enlarged view of a part of the two-cell assembly.

FIG. 7 is a plan view of a pack case constituting the battery pack of FIG. 6.

FIG. 8 is a side view illustrating the coupling structure between a two-cell assembly and a busbar frame assembly.

FIG. 9 is an enlarged view of portion “A” of FIG. 6.

FIG. 10 is a schematic perspective view of a vehicle including the battery pack according to one embodiment of the present disclosure.

In some of the attached drawings, corresponding components are given the same reference numerals. Those skilled in the art would appreciate that the drawings depict elements simply and clearly and have not necessarily been drawn to scale. For example, in order to facilitate understanding of various embodiments, the dimensions of some elements illustrated in the drawings may be exaggerated compared to other elements. Additionally, elements of the known art that are useful or essential in commercially viable embodiments may often not be depicted so as not to interfere with the spirit of the various embodiments of the present disclosure.

### DETAILED DESCRIPTION

The present disclosure is susceptible to various modifications and may have various embodiments, and specific embodiments will be described in detail below.

However, it is to be understood that this is not intended to limit the present disclosure to particular embodiments, but includes all modifications, equivalents, and substitutions falling within the spirit and technical scope of the present disclosure.

In the present disclosure, the terms such as “comprises” or “has” are intended to specify the presence of features, numerals, steps, operations, components, elements, or combinations thereof described herein, but are not intended to preclude the possibility of the presence or addition of one or more other features, numerals, steps, operations, components, elements, or combinations thereof.

Further, in the present disclosure, when a part such as a layer, film, region, or plate is described as being “on” another part, it includes not only a case where it is “directly above” the other part but also a case where there is another part interposed therebetween. Conversely, when a part such as a layer, film, region, or plate is described as being “under” another part, it includes not only a case where it is “directly below” the other part but also a case where there is another part interposed therebetween. Furthermore, in the present application, the expression “disposed on” may include a case where it is disposed not only on the upper side but also on the lower side.

In a battery pack having a cell-to-pack structure, a separate module housing is omitted, so that a thermal resin is directly interposed between the bottom surface of a battery assembly, in which a battery is exposed as it is, and a base plate of a pack case, which may promote conductive heat dissipation from the battery assembly and may allow the battery assembly to be more firmly fixed through curing of the thermal resin. In this way, recent battery packs tend to adopt a simplified design with fewer types of components, thereby improving the supply capacity of the battery pack and simplifying a cooling structure to enhance the cooling effects to cope with heat generation during rapid charging.

The battery pack structure in which the battery assembly is more firmly fixed through curing of the thermal resin provides advantages from the standpoint of a cell-to-pack structure, such as improved space utilization of the battery pack by directly assembling a plurality of batteries into the battery pack without modularizing them, and improved heat dissipation performance through heat conduction compared to a structure in which a module housing is additionally interposed.

However, the battery pack having a cell-to-pack structure has a simplified battery assembly structure, which makes it difficult to scale up in size due to structural stability concerns. When the structurally simplified battery assembly is scaled up so as to be suitable for the cell-to-pack structure, the difficulty of various processes such as transport and assembly increases, and the likelihood of defects may also increase. Furthermore, the conventional battery assembly structure involves bending the leads of battery cells and connecting busbars to every two or three battery cells in a busbar frame assembly. This process of assembling the busbar frame assembly is complex, and defects are likely to occur in the lead bending structure of the battery cell.

In view of such issues, the present disclosure provides a two-cell assembly and a battery pack including the same, which may simplify the process of assembling a busbar frame assembly to a conventional battery assembly, eliminate the process of bending leads of battery cells, and enable the simplified battery assembly to be directly mounted into a pack case.

In one embodiment according to the present disclosure, a two-cell assembly includes a first battery cell and a second battery cell each having cell leads with opposite polarities on both ends in a length direction, and a pair of busbar blocks, each joined to the same-polarity cell leads of the first battery cell and the second battery cell on opposite sides, and each having a bolt hole extending in a height direction, and the first battery cell and the second battery cell are connected in parallel via the pair of busbar blocks.

The two-cell assembly of the present disclosure having the above configuration may be directly mounted into a pack case as a unit of two battery cells. Accordingly, a simplified structure suitable for a cell-to-pack structure may be implemented, which is advantageous for scaling up in size, and even when the battery cells are large, steps such as transport and assembly may be smoothly carried out.

Hereinafter, embodiments of a two-cell assembly and a battery pack including the same according to the present disclosure will be described in detail with reference to the accompanying drawings. For reference, the directional terms such as front/rear or top/bottom/left/right used to identify relative positions in the following description are provided for ease of understanding the present disclosure, and unless otherwise specifically defined, are based on the directions illustrated in the drawings.

### First Embodiment

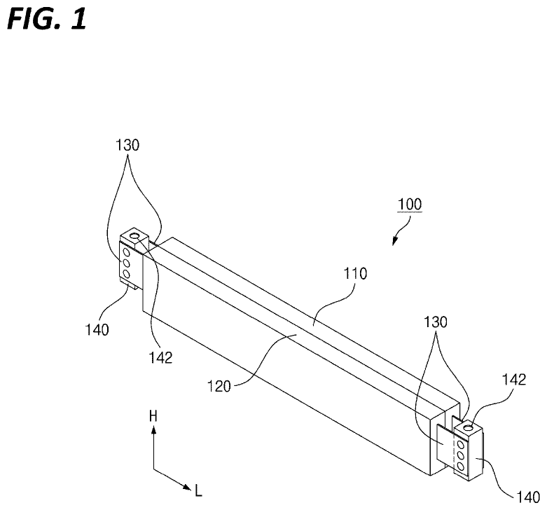

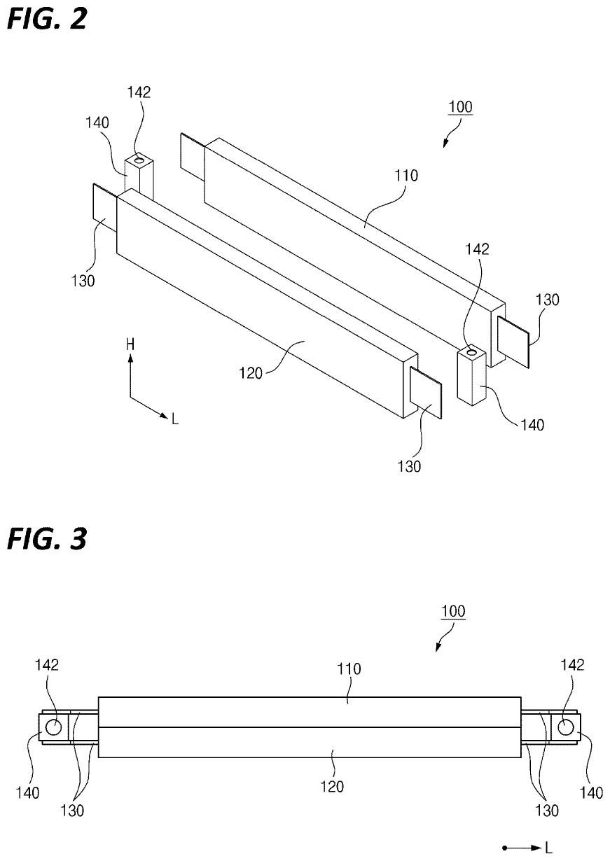

FIG. 1 is a perspective view of a two-cell assembly 100 according to one embodiment of the present disclosure, and FIG. 2 is an exploded perspective view of the two-cell assembly 100 of FIG. 1. Referring to FIGS. 1 and 2, the basic configuration of the two-cell assembly 100 provided by the present disclosure will be described.

The two-cell assembly 100 provided by the present disclosure includes a first battery cell 110 and a second battery cell 120, each having cell leads 130 with opposite polarities on both ends in the length direction L. The length direction L refers to the long-side direction of the first and second battery cells 110 and 120 in the drawings, and may alternatively be referred to as the overall length direction or overall width direction depending on the shape or arrangement of the battery cells 110 and 120. In this description, it may be understood that the cell leads 130 with opposite polarities are separately arranged on opposite sides of the battery cells 110 and 120. Although the first battery cell 110 and the second battery cell 120 are usually of the same specification, different types of battery cells may be used depending on the design.

The two-cell assembly 100 includes a pair of busbar blocks 140, each of which is joined to the same-polarity cell leads 130 of the first battery cell 110 and the second battery cell 120 on opposite sides, and has a bolt hole 142 extending in the height direction H. By the pair of electrically conductive busbar blocks 140, the same-polarity cell leads 130 of the first battery cell 110 and the second battery cell 120 are paired and electrically connected to each other. For example, the first battery cell 110 and the second battery cell 120 are connected in parallel by the pair of busbar blocks 140. Then, the rigid block structure ensures structurally stable coupling between a pair of cell leads 130.

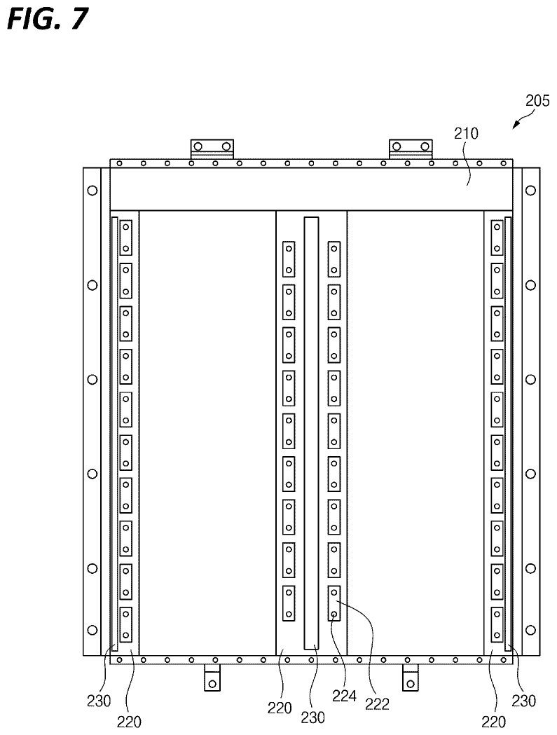

The two-cell assembly 100 referred to in this specification may be understood as a battery unit in which two battery cells 110 and 120 are electrically and structurally connected and treated as an integral unit when constituting a battery pack 200. A plurality of battery cells are mounted into a pack case 205 (see, e.g., FIG. 7) in units of the two-cell assembly 100, and the in-pack mounting structure of the two-cell assembly 100 will be described in a second embodiment.

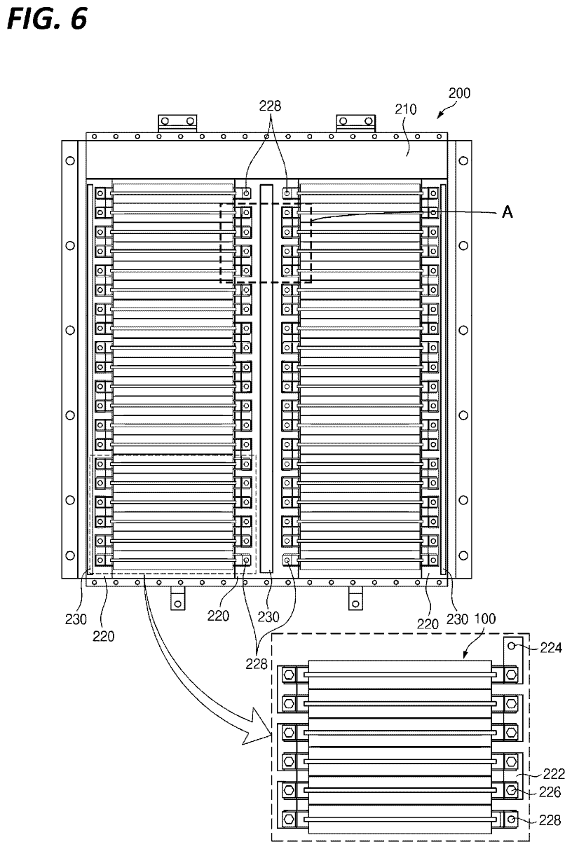

FIG. 3 is a plan view of the two-cell assembly 100 of FIG. 1. As clearly illustrated in FIGS. 1 to 3, each cell lead 130 of the first battery cell 110 and the second battery cell 120 may not include an integrated bending structure on the joining structure for the pair of busbar blocks 140. As a result, the assembly process of assembling battery cells with a busbar frame assembly 220 (see, e.g., FIG. 6), which electrically connects a plurality of battery cells, may be simplified, and defects due to the bending of leads of the battery cells may be avoided.

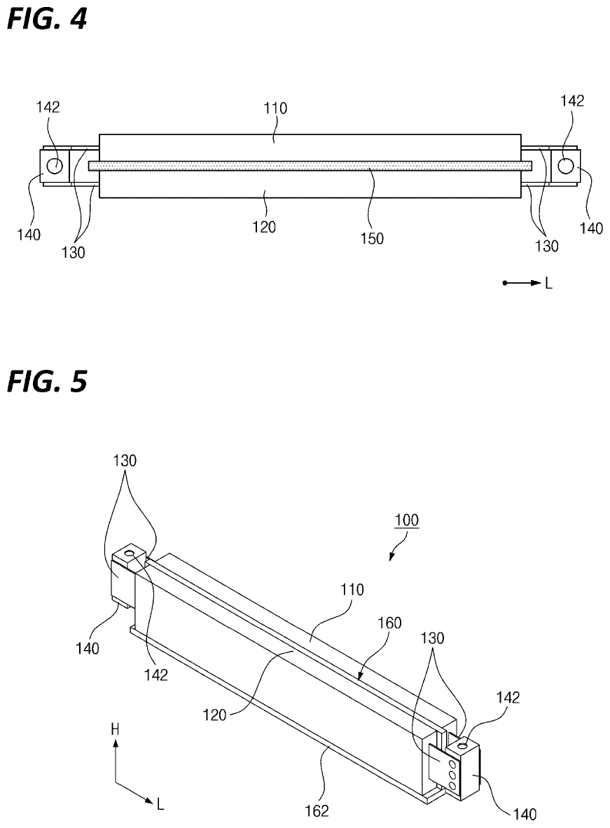

FIG. 4 is a plan view of the two-cell assembly 100 according to another embodiment of the present disclosure. The first battery cell 110 and the second battery cell 120 may come into contact with each other on facing sides thereof via a heat dissipation pad and/or a cushioning pad 150. For example, the heat dissipation pad and/or the cushioning pad 150 may be interposed between the first battery cell 110 and the second battery cell 120. The heat dissipation pad may help the temperatures of the first battery cell 110 and the second battery cell 120 become more uniform. Then, the elastic cushioning pad may improve the shock resistance of the two-cell assembly 100 and may absorb at least partially the volume expansion due to the swelling of the first battery cell 110 and the second battery cell 120. Depending on the embodiment, the heat dissipation pad may also serve to mitigate swelling.

FIG. 5 is a perspective view of the two-cell assembly 100 according to still another embodiment of the present disclosure. The first battery cell 110 and the second battery cell 120 may come into contact with each other on facing sides thereof via a cooling plate 160. For example, the cooling plate 160 may be interposed between the first battery cell 110 and the second battery cell 120. The cooling plate 160 functions to transfer heat generated from the first battery cell 110 and the second battery cell 120 to the outside by thermal conduction. For example, the cooling plate 160 may serve as a thermal conduction path to transfer the heat from the two-cell assembly 100 to a base plate 210 (see, e.g., FIG. 6) of the pack case 205. For effective cooling, the base plate 210 may include a heat sink, through which cooling water (coolant) flows. To expand the thermal conduction area of the cooling plate 160, the cooling plate 160 may include a bottom plate 162 that supports the bottom surfaces of the first battery cell 110 and the second battery cell 120. The bottom plate 162 may increase the thermal conduction area and may also enhance the stability of the coupling structure between the first battery cell 110 and the second battery cell 120.

### Second Embodiment

FIG. 6 is a plan view of the battery pack 200 according to one embodiment of the present disclosure, and FIG. 7 is a plan view of the pack case 205 constituting the battery pack 200 of FIG. 6. The illustrated battery pack 200 includes a plurality of two-cell assemblies 100 described in the first embodiment, and the plurality of two-cell assemblies 100 are installed such that the busbar blocks 140 on both ends in the length direction L are oriented in the height direction H. According to one embodiment, the plurality of two-cell assemblies 100 are mounted to the busbar frame assembly 220 installed in the pack case 205 via the busbar blocks 140. As illustrated in FIG. 7, in the battery pack 200 of the present disclosure, the busbar frame assembly 220, which was included as part of a conventional battery assembly, is installed on the base plate 210 forming the bottom surface of the pack case 205.

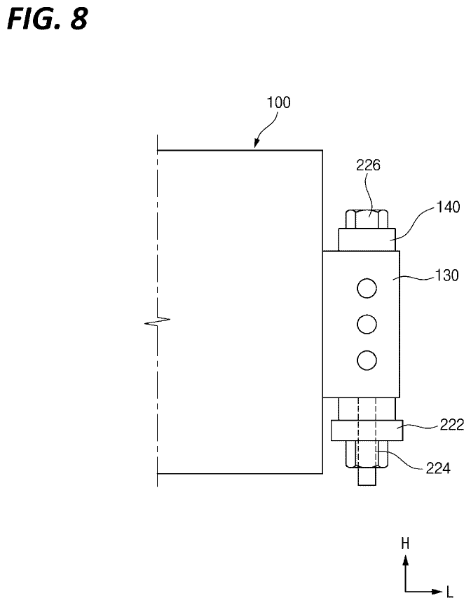

FIG. 8 is a side view illustrating the coupling structure between the two-cell assembly 100 and the busbar frame assembly 220. The busbar frame assembly 220 is provided with a plurality of busbars 222, each having a pair of nut holes 224 that communicate with the bolt hole 142 of the busbar block 140 included in the two-cell assembly 100, and each connecting the cell leads 130 of adjacent two-cell assembly 100 in series.

Through such a structure of the busbar frame assembly 220 and the structure in which through-holes of the busbar blocks 140 extend along the height direction H, the plurality of two-cell assemblies 100 may be fixed to the busbar frame assembly 220 and electrically connected to each other by a plurality of bolts 226, which pass through the bolt holes 142 of the busbar blocks 140 and are fastened into the nut holes 224 of the busbars 222.

The plurality of two-cell assemblies 100, for example, electrically connected in a row by the busbar frame assembly 220, are connected in series. Referring to FIG. 6, adjacent two-cell assemblies 100 are mounted together on one busbar 222 with the busbar blocks 140 on both ends in the length direction L having opposite polarities, and a plurality of busbars 222 arranged in a row have alternating polarities. This alternating polarity connection of the busbar blocks 140 exhibits the same pattern on both ends in the length direction L of the two-cell assemblies 100.

According to the alternating polarity connection of the busbar blocks 140, among the plurality of two-cell assemblies 100 arranged in a row, each of the outermost two-cell assemblies 100 has one busbar block 140 that is not connected to the busbars 222. These remaining busbar blocks 140 have opposite polarities and serve as output terminals 228 for a group of two-cell assemblies 100 that are electrically connected by the busbar frame assembly 220. A pair of output terminals 228 may be used for connection to another group of two-cell assemblies 100 and/or for connection to in-pack electrical components such as a Battery Disconnection Unit (BDU) or a Battery Management System (BMS). The pair of output terminals 228 may not be connected to the busbars 222 and may remain in the form of the cell leads 130, or may be joined to another type of busbars (not illustrated).

In the battery pack 200 of the present disclosure, the busbar frame assembly 220 is installed on the base plate 210. Due to the in-pack installation structure of the busbar frame assembly 220, the plurality of busbars 222 included in the busbar frame assembly 220 may be cooled via the base plate 210. In the battery pack 200, although the busbars 222 form a high-temperature region due to current concentration, in the present disclosure, the busbars 222 may be effectively cooled through the base plate 210. In this respect, the battery pack 200 of the present disclosure offers a significant advantage from the standpoint of heat management compared to the related art.

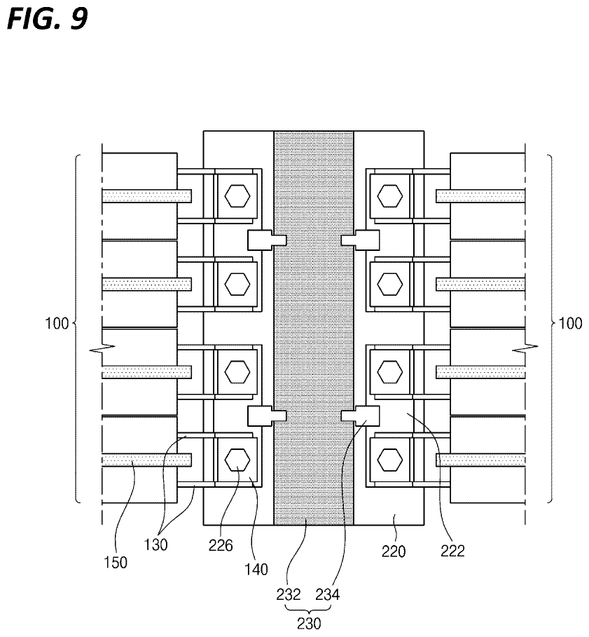

FIG. 9 is an enlarged view of portion “A” of FIG. 6. In the embodiment of FIG. 9, an integrated circuit assembly 230 including a plurality of sensing plates 234 is installed to the busbar frame assembly 220. Each of the plurality of sensing plates 234 may be electrically connected to one busbar 222. The plurality of sensing plates 234 may be integrated on a flexible printed circuit board (FPCB) 232, which constitutes part of the integrated circuit assembly 230.

Each of the plurality of sensing plates 234 may have a patch shape or a pad shape. The plurality of sensing plates 234 may include a conductive material. The plurality of sensing plates 234 may each be short-circuited to the corresponding busbar 222. Each of the plurality of sensing plates 234 may be included as part of the integrated circuit assembly 230 via the flexible printed circuit board 232. The voltage of each busbar 222 may be measured through the plurality of sensing plates 234.

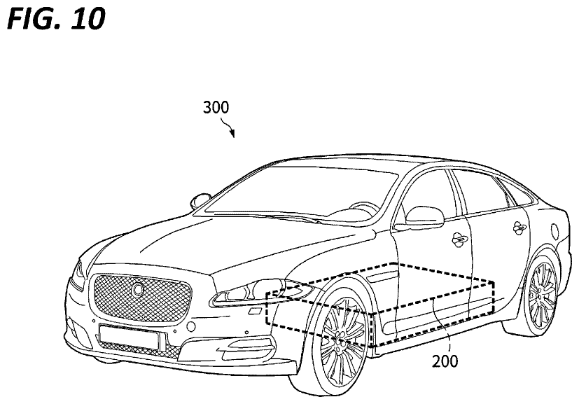

FIG. 10 is a schematic perspective view of a vehicle including the battery pack 200 according to one embodiment of the present disclosure.

The battery pack 200 according to the present disclosure may be included in a vehicle 300, as illustrated in FIG. 10. For example, the battery pack 200 according to the present disclosure may be mounted in the vehicle 300 such as an electric vehicle (EV) or a hybrid vehicle (HV) and may supply power to drive the vehicle 300.

In the foregoing, the present disclosure has been described in detail with reference to the drawings and embodiments. However, the embodiments described in this specification and the configurations illustrated in the drawings are merely exemplary embodiments of the present disclosure, and do not represent all the technical ideas of the present disclosure. Therefore, it should be understood that, at the time of filing, there may be various equivalents and modifications that could serve as alternatives to the embodiments.

What is claimed is:

1. A two-cell assembly comprising:
a first battery cell and a second battery cell each having cell leads with opposite polarities on both ends in a length direction; and
a pair of busbar blocks, each joined to the same-polarity cell leads of the first battery cell and the second battery cell on opposite sides, and each having a bolt hole extending in a height direction,
wherein the first battery cell and the second battery cell are connected in parallel via the pair of busbar blocks.

2. The two-cell assembly according to claim 1, wherein each cell lead of the first battery cell and the second battery cell does not include a bending structure on a joining structure for the pair of busbar blocks.

3. The two-cell assembly according to claim 1, wherein the first battery cell and the second battery cell come into contact with each other on facing sides thereof via a heat dissipation pad and/or a cushioning pad.

4. The two-cell assembly according to claim 1, wherein the first battery cell and the second battery cell come into contact with each other on facing sides thereof via a cooling plate.

5. The two-cell assembly according to claim 4, wherein the cooling plate includes a bottom plate that supports bottom surfaces of the first battery cell and the second battery cell.

6. A battery pack comprising:
a plurality of the two-cell assemblies according to claim 1; and
a pack case including a busbar frame assembly on which the plurality of two-cell assemblies are mounted with the busbar blocks oriented in a height direction, and on which the busbar blocks are also mounted.

7. The battery pack according to claim 6, wherein the busbar frame assembly is installed on a base plate of the pack case.

8. The battery pack according to claim 7, wherein the busbar frame assembly is provided with a plurality of busbars, each having a pair of nut holes that communicate with the bolt hole of the busbar block, and each connecting the cell leads of adjacent two-cell assemblies in series.

9. The battery pack according to claim 8, wherein the plurality of two-cell assemblies are fixed to the busbar frame assembly and are electrically connected to each other by a plurality of bolts that pass through the bolt holes of the busbar blocks and are fastened to the nut holes of the busbars.

10. The battery pack according to claim 9, wherein the busbar blocks or cell leads of outermost two-cell assemblies, among a plurality of two-cell assemblies arranged in a row, form a pair of output terminals with opposite polarities for the plurality of two-cell assemblies fixed to the busbar frame assembly.

11. The battery pack according to claim 8, wherein the plurality of busbars of the busbar frame assembly are cooled via the base plate.

12. The battery pack according to claim 9, wherein the busbar frame assembly is provided with an integrated circuit assembly including a plurality of sensing plates.

13. The battery pack according to claim 12, wherein each of the plurality of sensing plates is electrically connected to one busbar.

14. The battery pack according to claim 13, wherein the sensing plate measures a voltage of the electrically connected busbar.

15. A pack case comprising:
a plurality of two-cell assemblies; and
a pack case including a busbar frame assembly on which the plurality of two-cell assemblies are mounted with a busbar block oriented in a height direction, and on which the busbar block is also mounted,
wherein each of the plurality of two-cell assemblies includes:
a first battery cell and a second battery cell each having cell leads with opposite polarities on both ends in a length direction; and
a pair of the busbar blocks, each joined to the same-polarity cell leads of the first battery cell and the second battery cell on opposite sides, and each having a bolt hole extending in the height direction,
wherein the first battery cell and the second battery cell are connected in parallel via the pair of busbar blocks.

16. The pack case according to claim 15, wherein the busbar frame assembly is installed on a base plate of the pack case.

17. The pack case according to claim 16, wherein the busbar frame assembly is provided with a plurality of busbars, each having a pair of nut holes that communicate with the bolt hole, and each connecting the cell leads of adjacent two-cell assemblies in series.

18. The pack case according to claim 17, wherein the plurality of two-cell assemblies are fixed to the busbar frame assembly and are electrically connected to each other by a plurality of bolts that pass through the bolt hole and are fastened to the nut holes.

19. The pack case according to claim 18, wherein the busbar blocks or cell leads of outermost two-cell assemblies, among a plurality of two-cell assemblies arranged in a row, form a pair of output terminals with opposite polarities for the plurality of two-cell assemblies fixed to the busbar frame assembly.

20. A vehicle comprising at least one battery pack according to claim 6.
